(19) United States
(12) Patent Application Publication
(10) Pub. No.: US 2014/0085552 A1
(43) Pub. Date: Mar. 27, 2014

(54) SHADING DEVICE OF ACTIVE SWITCHING 3D DISPLAY

(71) Applicants: SHIH-HSI JEN, TAIPEI CITY (TW); YI-HSUAN HUANG, BAOSHAN TOWNSHIP (TW)

(72) Inventors: SHIH-HSI JEN, TAIPEI CITY (TW); YI-HSUAN HUANG, BAOSHAN TOWNSHIP (TW)

(21) Appl. No.: 13/625,848

(22) Filed: Sep. 24, 2012

(51) Int. Cl. G02F 1/1335

(52) U.S. Cl. 349/15

(57) ABSTRACT

A shading device of an active switching 3D display includes a first main body, at least one second main body, a control circuit board, a pair of LCD chips, a first detector and at least one second detector. The control circuit board and the pair of LCD chips are installed on the first main body, and the first detector is installed on the first main body, and the second detector is installed on an internal side of the LCD chip, and the first and second detectors are electrically coupled to the control circuit board, and the first detector and/or the second detector receive a 3D signal and/or an optical signal to switch to a 3D display function and/or a shading functions without requirement a manual switching operation, so as to improve the convenience of use.

### BACKGROUND OF THE INVENTION

1. Field of the Invention

The present invention relates to the technical field of a shading display device, and more particularly to the shading device of an active switching 3D display capable of switching to a 3D display or a shading effect automatically according to different received signals.

2. Description of the Related Art

In recent years, display technologies have an increasingly higher demand for vivid and lifelike images as the quality of our life improves and advance from 2D displays to 3D displays to provide viewers a virtual 3D vision to meet the true image requirements. The principle of 3D display technologies mainly adopts the parallax between two eyes of a person. Since our left and right eyes are usually separated with a distance approximately equal to 6.5 cm, therefore an image of an object received by both eyes may have a slight difference if the object is viewed from a slightly different angle, and our brain receives and combines the two slightly different images to form a visual image with depth information, so that the image information can be read with a higher reliability.

However, a display device is generally installed at a fixed position, so that our left and right eyes must receive the aforementioned slightly different images in order to receive 3D images. At present, the 3D display technology is mainly divided into two types, respectively: an eyeglasses type 3D technology and a naked-eye 3D technology, and the eyeglasses type 3D technology can be mainly divided into the following types:

1. Anaglyph Glasses: The anaglyph glasses are comprised of a red lens and a bluish green lens, so that our left and right eyes can filter images of different colors to produce parallax and form 3D images. These glasses have the drawback of loosing some of the colors, so that only the gray-scale or monochromic screen can be seen.

2. Polarizer: The polarizer is comprised of a horizontal polarizer and a vertical polarizer and provided for receiving 3D images composed of different polarized lights. This polarizer has the drawback of completely filtering all of the lights coming from another direction when a viewer's head is tilted, and an eye receives images of another eye, thus causing discomfort to the viewing.

3. LC Shutter Glasses: The LC shutter glasses are comprised of a pair of LCD chips, and capable of alternately switching the colors of odd and even images by controlling the pair of LCD chips, so that the viewer's left and right eyes receive different images to produce the 3D feel. At present, the LC shutter glasses are used most extensively and provide the best 3D display effect, but the LC shutter glasses have the drawback of requiring a precision electronic control technology and incurring a high cost.

4. Helmet type display device: This display device has a screen separately installed at positions corresponding to the viewer's left and right eyes, and the two screens have different image signals, and parallax is used to form the 3D image directly.

The drawbacks of this display device reside on its being used for only one viewer at a time only, a high price, and a heavy weight that causing inconvenient carry and use.

Although the aforementioned LC shutter glasses and helmet type display device provide the best effect, users have to operate them manually such as switching the power switch or adjusting the brightness and image manually. In the market, sunglasses with the LCD chips used for the shading effect are available, and different levels of brightness of the LCD chip can be adjusted, so that these sunglasses are suitable for conducting various activities under the sun. Sunglasses with the LC shutter glasses or the LCD chip for the shading effect are single-function products. Although their structures are relatively similar, yet the functions cannot be shared. Therefore, sunglasses of this sort are lack of practicality or incurring extra wastes.

### SUMMARY OF THE INVENTION

In view of the problems of the prior art, it is a primary objective of the present invention to provide a shading device of an active switching 3D display, wherein a first detector for receiving 3D signals and at least one second detector for receiving optical signals are used, such that after the 3D signal or the optical signal is received, the device switches and uses a stereo video or shading function automatically to improve the convenience of use significantly.

Another objective of the present invention is to provide a shading device of an active switching 3D display with both functions of 3D glasses and sunglasses, so as to improve the practicality of the device significantly.

To achieve the aforementioned objectives, the present invention provides a shading device of an active switching 3D display, comprising: a first main body including a containing space formed therein; at least one second main body, pivoted on the first main body; a control circuit board, installed in the containing space, and comprising a control chip, a power switch and an electric power supply installed thereon, and the control chip being electrically coupled to the power switch and the electric power supply, and the power switch is installed at a pivoting position of the first main body and the second main body, and movable to switch electricity supply to the control chip; a pair of LCD chips, installed on the first main body, and respectively and electrically coupled to the control chip and the electric power supply;

a first detector, installed on a surface of the first main body, and electrically coupled to the power switch of the control circuit board, for sensing the 3D signal to actuate the pair of LCD chips to change colors alternately; and at least one second detector, installed on an internal side of the pair of LCD chips and electrically coupled to the power switch of the control circuit board, for sensing the optical signal to actuate the pair of LCD chips to change colors synchronously.

In a preferred embodiment, the first main body is a lens frame structure having two lens rims for installing the pair of LCD chips, and the second main body is comprised of a pair of lens arms respectively and pivotally coupled to two side edges of the first main body. The lens frame structure is a glasses structure applicable for users who do not wear eyeglasses.

In another preferred embodiment, the first main body is a lens frame structure having two lens rims for installing the pair of LCD chips, and the second main body has a clamp structure pivotally coupled to a side of the first main body for clamping onto eyeglasses applicable for users who wear eyeglasses.

The shading device of an active switching 3D display of the present invention further comprises a solar panel installed on the first main body and or the second main body and electrically coupled to the control circuit board for converting solar energy into electric energy and saving the electric energy in the electric power supply. Wherein, the electric power supply is a mercury battery, a storage battery or a combination thereof that can reduce the use of the battery, not only saving the cost of use, but also reducing the post-handling issue of the battery.

### BRIEF DESCRIPTION OF THE DRAWINGS

FIG. 1 is a schematic view of a structure in accordance with a first preferred embodiment of the present invention;

FIG. 2 is a block diagram of hardware of the first preferred embodiment of the present invention;

FIG. 3 is a schematic view of a using status of the first preferred embodiment of the present invention;

FIG. 4 is a schematic view of a structure in accordance with a second preferred embodiment of the present invention; and

FIG. 5 is a schematic view of a using status of the second preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

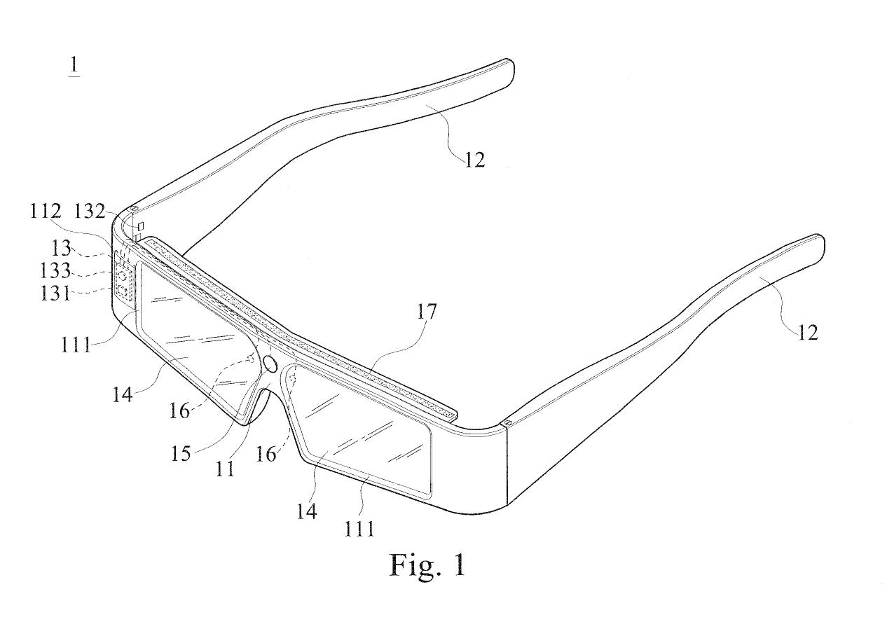

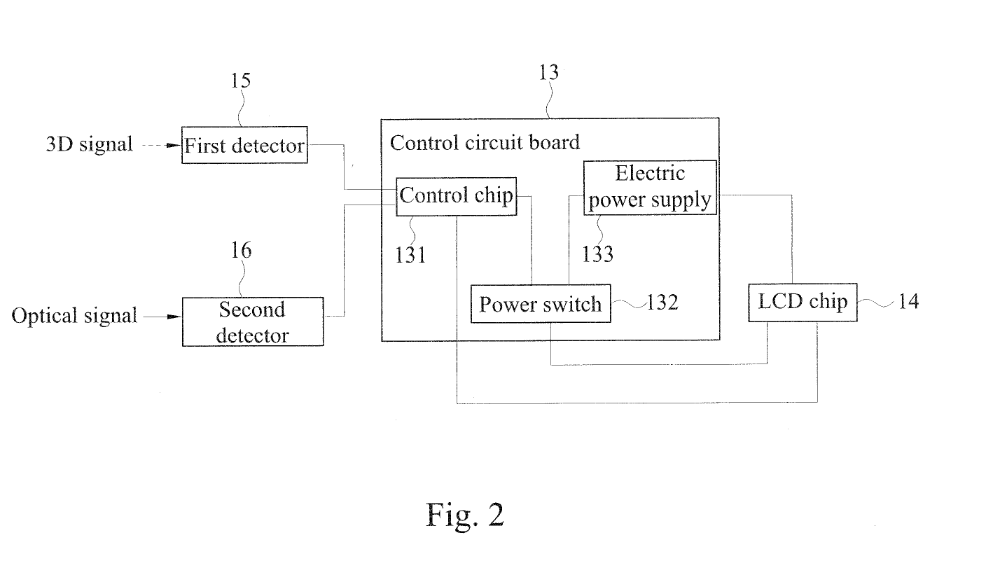

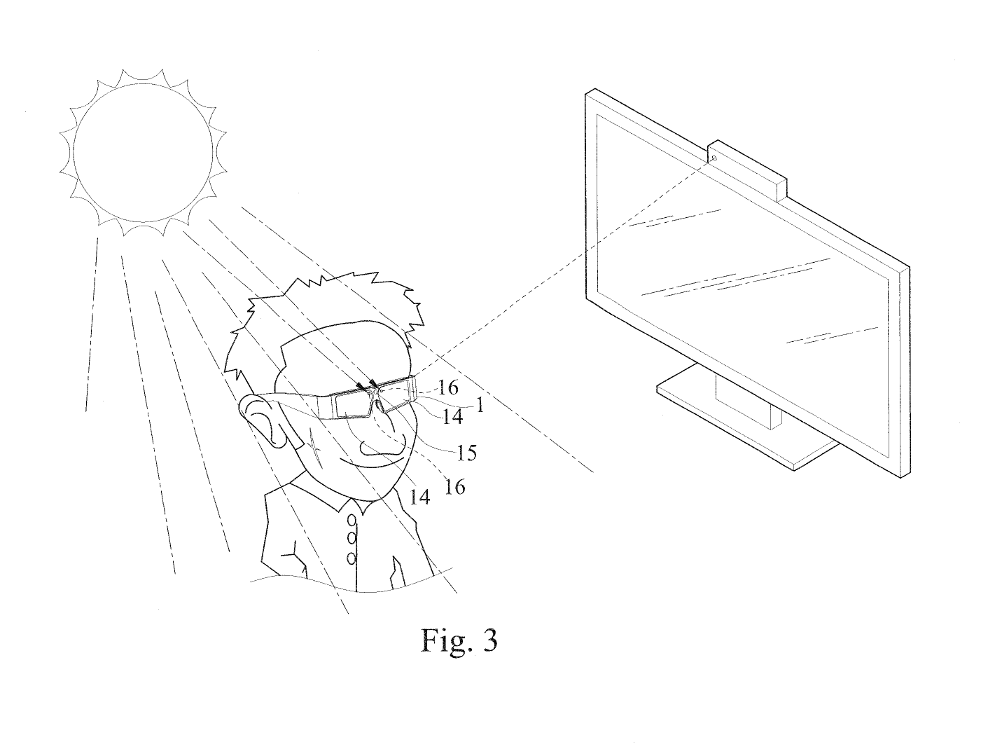

With reference to FIGS. 1, 2, 3 for a schematic view of the structure, a block diagram of hardware, and a schematic view of a using status of a shading device of an active switching 3D display 1 in accordance with the first preferred embodiment of the present invention respectively, the shading device of the active switching 3D display 1 comprises a first main body 11, a pair of second main bodies 12, a control circuit board 13, a pair of LCD chips 14, a first detector 15 and a pair of second detectors 16.

The first main body 11 has a lens frame structure having two lens rims 111 for installing the pair of LCD chips 14 respectively, and the first main body 11 has a containing space 112 formed therein.

The pair of second main bodies 12 are a pair of lens arms, and a distal end of the pair of second main bodies 12 is movably and pivotally to two edges of the lens rim 111 of the first main body 11. Therefore, the first main body 11 and the pair of second main bodies 12 constitute the form of eyeglasses provided for users who wear or do not wear eyeglasses.

The control circuit board 13 is installed in the containing space 112 and comprises a control chip 131, a power switch 132 and an electric power supply 133, wherein the control chip 131 is electrically coupled to the power switch 132 and the electric power supply 133, and the power switch 132 is installed at a pivoting position of the first main body 11 and the second main body 12. The second main body 12 is rotated with respect to the first main body 11 namely the necessary action when wearing glasses, the power switch 132 simultaneously actuate and switch electricity to be supplied to the control chip 131. It is noteworthy that the power switch 132 is a common micro switch, but the invention is not limited to micro switches only.

The pair of LCD chips 14 are installed in the pair of lens rims 111 of the first main body 11, and respectively and electrically coupled to the control chip 131 and the electric power supply 133. It is noteworthy that the pair of LCD chips 14 are controlled by the control chip 131 to preset the luminance for adjusting the brightness of changing the colors of the pair of LCD chips 14, and the adjusting operation can be set manually by users, or the control chip 131 is combined with the pair of second detectors 16 to self-adjust with the brightness.

The first detector 15 is installed on a surface of the first main body 11, specifically at the front of a connecting position of the lens rims 111 in order to receive a 3D signal more easily, and the first detector 15 is electrically coupled to the power switch 132 of the control circuit board 13, and the first detector 15 is provided for receiving and sensing the 3D signal to actuate the pair of LCD chips 14 to change colors alternately and automatically switch to a 3D display function. The pair of second detectors 16 are installed on an internal side of the pair of LCD chips 14, particularly at positions such as the position of a nose bridge that will not block the vision of a user, and the second detectors 16 are electrically coupled to the power switch 132 of the control circuit board 13 and provided for sensing an optical signal to actuate the pair of LCD chips 14 to change colors synchronously. It is noteworthy that the pair of second detectors 16 are general optical detectors, wherein the control chip 131 is used primarily for controlling the first detector 15 to receive and sense the 3D signal, and the pair of second detectors 16 assists the operation of receiving the optical signal, such that when the device is not used for 3D display, the present invention can be used as sunglasses to shade the sun during outdoor activities. In addition, the power consumed by the pair of LCD chips 14 of the shading device of the active switching 3D display 1 of the present invention is very low, and a solar panel 17 can be installed on the first main body 11, and the solar panel 17 is electrically coupled to the electric power supply 133 of the control circuit board 13 for converting solar energy into electric energy and storing the electric energy into the electric power supply 133 for power supply of the present invention, so as to reduce the power consumption significantly. In addition, the electric power supply 133 is a common mercury battery, storage battery, or a combination thereof, but the invention is not limited to these types of batteries only.

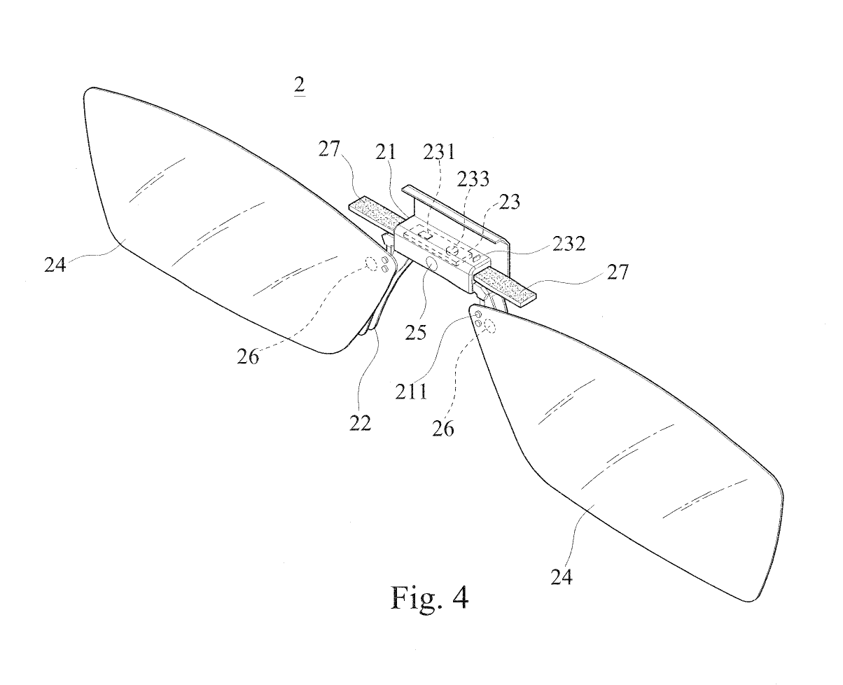

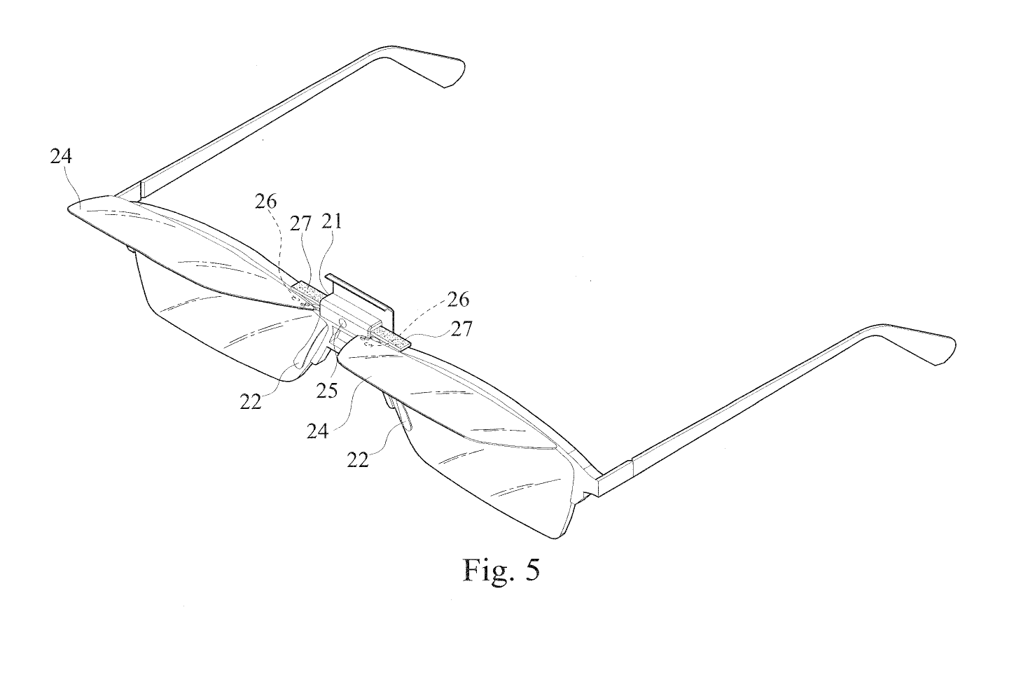

With reference to FIGS. 4 and 5 for a schematic views of the structure and a using status of a shading device of an active switching 3D display 2 in accordance with the second preferred embodiment of the present invention respectively, the shading device of the active switching 3D display 2 also comprises a first main body 21, a second main body 22, a control circuit board 23, a pair of LCD chips 24, a first detector 25 and a pair of second detectors 26. Wherein, the first main body 21 also comes with a lens frame structure having two lens rims 211 for installing the pair of LCD chips 24, and the control circuit board 23 is installed in a containing space 212 of the first main body 21. The second main body 22 comes with a clamp structure and is pivotally installed on a side of the first main body 21 and both of the first main body 21 and the second main body 22 are clamped onto regular eyeglasses to facilitate the application of the present invention, and such design is a big favor to users who originally wear glasses. The control circuit board 73 also comprises a control chip 731, a power switch 232 and an electric power supply 233 electrically coupled to the control circuit board 23, and the electric connection is the same as described above, and thus will not be repeated. The power switch 232 is also installed at a pivoting position of the first main body 21 and the second main body 22. The shading device of the active switching 3D display 2 of the second preferred embodiment also comprises a solar panel 27 installed at the top of the second main body 22, and its electric connection is the same as that of the first preferred embodiment, and thus will not be repeated.

In summation of the description above, the shading device of the active switching 3D display 1, 2 of the present invention uses the first detector 15, 25 and the second detector 16, 26 for receiving the 3D signal and the optical signal respectively, such that after the 3D signal or the optical signal is received, the 3D display function or shading function can be switched automatically to improve the convenience of use significantly, and the present invention can be used for both 3D videos or shading functions to enhance the practicality of the invention significantly.

What is claimed is:

1. A shading device of an active switching 3D display, for receiving a 3D signal or an optical signal to switch to a 3D display function or a shading function automatically, comprising:
a first main body, including a containing space formed therein;
at least one second main body, pivoted on the first main body;
a control circuit board, installed in the containing space, comprising a control chip, a power switch and an electric power supply installed thereon, the control chip being electrically coupled to the power switch and the electric power supply respectively, and the power switch being installed at a pivoting position of the first main body and the second main body, wherein with respect to the pivot of the first main body and the second main body, the power switch simultaneously actuate and switch electricity to be supplied to the control chip;
a pair of LCD chips, installed on the first main body, and respectively and electrically coupled to the control chip and the electric power supply;
a first detector, installed on a surface of the first main body, and electrically coupled to the power switch of the control circuit board, for sensing the 3D signal to actuate the pair of LCD chips to change colors alternately; and
at least one second detector, installed on an internal side of the pair of LCD chips and electrically coupled to the power switch of the control circuit board, for sensing the optical signal to actuate the pair of LCD chips to change colors synchronously.

2. The shading device of the active switching 3D display according to claim 1, wherein the first main body is a lens frame structure having two lens rims for installing the pair of LCD chips, and the second main body is comprised of a pair of lens arms respectively and pivotally coupled to two side edges of the first main body.

3. The shading device of the active switching 3D display according to claim 1, wherein the first main body is a lens frame structure having two lens rims for installing the pair of LCD chips, and the second main body is a clamp structure pivotally coupled to a side of the first main body.

4. The shading device of the active switching 3D display according to claim 1, further comprising a solar panel installed on the first main body and electrically coupled to the control circuit board for converting solar energy into electric energy and saving the electric energy in the electric power supply.

5. The shading device of the active switching 3D display according to claim 1, further comprising a solar panel installed on the second main body and electrically coupled to the control circuit board for converting solar energy into electric energy and saving the electric energy in the electric power supply.

6. The shading device of the active switching 3D display according to claim 1, wherein the electric power supply is one selected from the collection of a mercury battery, a storage battery and a combination thereof.
